(19) United States
(12) Patent Application Publication
(10) Pub. No.: US 2014/0197819 A1
(43) Pub. Date: Jul. 17, 2014

(54) METHOD FOR POSITIONING BASED ON MAGNETIC FIELD CHARACTERISTICS AND SYSTEM THEREOF

(71) Applicant: INDUSTRIAL TECHNOLOGY RESEARCH INSTITUTE, Hsinchu (TW)

(72) Inventors: Wan-Jung LIN, New Taipei City (TW); Kun-Long CHEN, New Taipei City (TW); Lun-Chia KUO, Taichung City (TW)

(21) Appl. No.: 13/940,927

(22) Filed: Jul. 12, 2013

(30) Foreign Application Priority Data
Jan. 15, 2013 (TW) 102101461

(51) Int. Cl. G01B 7/00

(52) U.S. Cl. CPC G01B 7/003
USPC 324/207.11

(57) ABSTRACT

A system for positioning based on magnetic field characteristics includes a system apparatus and a client device. The system apparatus includes a characteristic magnetic field generation device, a magnetic field characteristic database and a processing device. The characteristic magnetic field generation device is used for generating a plurality of characteristic magnetic fields in a predetermined space. The characteristic magnetic fields have at least two magnetic field characteristics. The magnetic field, characteristic database has a plurality of characteristic values and a plurality of positioning values. Each of the characteristic values corresponds to each of the magnetic field characteristics. The characteristic values correspond to the magnetic field characteristics. The client device includes a magnet detecting component and a processor. The magnet detecting component is used for detecting the magnetic field characteristics and for outputting a magnetic field signal. The processor is used for collecting and processing the magnetic field signal.

### CROSS-REFERENCE TO RELATED APPLICATIONS

This non-provisional application claims priority under 35 U.S.C. §119(a) on Patent Application No(s). 102101461 filed in Taiwan, R.O.C. on Jan. 15, 2013, the entire contents of which are hereby incorporated by reference.

### TECHNICAL FIELD

The disclosure relates to a positioning method and system thereof.

### BACKGROUND

Global Positioning System (GPS) is by far the most mature technology in terms of positioning method. However, the limitation of line of sight prevents GPS from performing positioning in the environment having screens. For example, positioning cannot be performed in a parking lot or in an indoor space. To address this issue, technologies such as Wi-Fi, Ultra Wideband (UWB) and Radio Frequency Identification (RFID) are developed and are introduced. Nonetheless, these technologies require extra equipments and thereby increase costs of establishment and maintenance.

### SUMMARY

A system for positioning based on magnetic field characteristics comprises a system apparatus and a client device. The system apparatus comprises a characteristic magnetic field generation device, a magnetic field characteristic database and a processing device. The characteristic magnetic field generation device is configured for generating a plurality of characteristic magnetic fields in a predetermined space. The characteristic magnetic fields have at least two magnetic field characteristics. The magnetic field characteristic database has a plurality of characteristic values and a plurality of positioning values. Each of the characteristic values corresponds to each of the positioning values. The characteristic values correspond to the magnetic field characteristics. The client device comprises a magnet detecting component and a processor. The magnet detecting component is configured for detecting the magnetic field characteristics and for outputting a magnetic field signal. The processor is configured for collecting and processing the magnetic field signal. When the magnetic field signal which has been processed generates a unit characteristic, the processor is configured for transmitting the unit characteristic to the processing device. After looking for one of the characteristic values corresponding to one of the positioning values, the processing device is configured for outputting the corresponding positioning value.

Characterized another way, a system for positioning based on magnetic field characteristics comprises a system apparatus. The system apparatus is configured for collecting a unit characteristic. The system apparatus comprises a characteristic magnetic field generation device, a magnetic field characteristic database and a processing device. The characteristic magnetic field generation device is configured for generating a plurality of characteristic magnetic fields. The characteristic magnetic fields have at least two magnetic field characteristics. The magnetic field characteristic database has a plurality of characteristic values and a plurality of positioning values. Each of the characteristic values corresponds to the positioning values. The characteristic values correspond to the magnetic field characteristics. The processing device is configured for receiving the unit characteristic. After looking for one of the characteristic values corresponds to one of the positioning values, the processing device is configured for outputting the corresponding positioning value.

Furthermore, a system for positioning based on magnetic field characteristics comprises a client device. The client device is configured for a predetermined space with a plurality of characteristic magnetic fields. The client device comprises a magnetic field detecting component and a processor. The magnetic field detecting component is configured for detecting the characteristic magnetic fields and outputting a magnetic field signal. The processor is configured for receiving and processing the magnetic field signal, and is configured for outputting a unit characteristic when the magnetic field signal which has been processed forms the unit characteristic.

A method for positioning based on magnetic field characteristics comprises the steps of: generating a plurality of characteristic magnetic fields in a predetermined space in which the characteristic magnetic fields have at least two magnetic field characteristics; receiving a unit characteristic; looking for a characteristic value corresponding to the unit characteristic and a positioning value corresponding to the characteristic value; and outputting the positioning value.

Moreover, a system for positioning based on magnetic field characteristics comprises a system apparatus and a client device. The system apparatus comprises a characteristic magnetic field generation device, a magnetic field characteristic database and a processing device. The characteristic magnetic field generation device is configured for generating a plurality of characteristic magnetic fields. The characteristic magnetic fields have at least two magnetic field characteristics. The magnetic field characteristic database has a plurality of characteristic values and a plurality of positioning values. Each of the characteristic values corresponds to each of the positioning values. The characteristic values correspond to the magnetic field characteristics. The client device comprises a magnetic field detecting component and a processor. The magnetic field detecting component is configured for detecting the characteristic magnetic fields and for outputting a magnetic field signal. The processor is configured for passing the magnetic field signal to processor device. The processor device is configured to process the magnetic field signal and acquire a unit characteristic and looking for a characteristic value corresponding to the unit characteristic and a positioning value corresponding to the characteristic value; and outputting the positioning value.

### BRIEF DESCRIPTION OF THE DRAWINGS

The disclosure will become more fully understood from the detailed description given herein below for illustration only and thus does not limit the disclosure, wherein:

FIG. 1 is a block diagram of a system for positioning based on magnetic field characteristics according to a first embodiment of the disclosure;

FIGS. 2A, 2B, 2C and 2D are schematic graphs of characteristic magnetic fields generated by the magnet group;

FIG. 3 is a block diagram of client device according to another embodiment of the disclosure;

FIGS. 4A, 4B, and 4C are line graphs of characteristic magnetic fields of the magnet group under different measuring heights according to the disclosure;

FIGS. 5A, 5B, 5C, 5D, 6A, 6B, 6C and 6D are line graphs of characteristic magnetic fields of the magnet group under the magnet distance and the magnetic pole arrangement according to the disclosure;

FIGS. 7A, 7B, 7C and 7D are line graphs of characteristic magnetic fields of the set of magnets under different elevation angles according to the disclosure;

FIG. 8 is a schematic view of a characteristic magnetic field generation device disposed at a predetermined space according to another embodiment of the disclosure;

FIGS. 9A, 9B, 9C and 9D are perspective views of the arrangement of magnets according to the disclosure; and

FIG. 10 is a flow chart of the method for positioning based on magnetic field characteristics according to the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

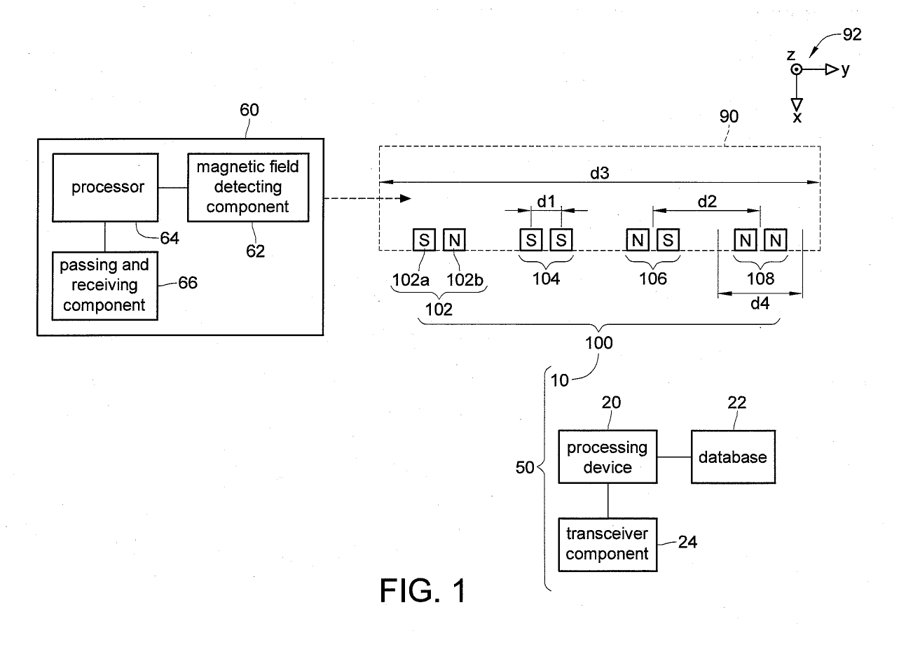

Firstly, please refer to FIG. 1, which is a block diagram of a system for positioning based on magnetic field characteristics according to a first embodiment of the disclosure. To simplify the explanation, in this embodiment, the predetermined space 90 is a single axis and rectangular space, and FIG. 1 illustrates the top view of the predetermined space. The predetermined space 90 may be a shopping mall, a storeroom, a warehouse, an indoor aisle or an outdoor pavement. This method for positioning provides information regarding positions directly. Thereby, if this method for positioning is used with GPS or Wi-Fi, the length of the predetermined space 90 may be the minimum length that GPS or Wi-Fi can recognize. The accuracy of the positioning of GPS Wi-Fi is therefore improved.

In the first embodiment, method for positioning comprises a system apparatus 50 and client device 60. In the application of the first embodiment, when the client device moves along the arrow direction, the system apparatus 50 is configured for acquiring the horizontal position (as shown in the figure) of the client device 60.

The system apparatus 50 comprises a characteristic magnetic field generation device 10, a processing device 20 and a magnetic field characteristic database 22.

The characteristic magnetic field generation device is configured for generating a plurality of characteristic magnetic fields in the predetermined space 90. Each of the characteristic magnetic fields may have single or a plurality of magnetic field characteristics. Specifically, the characteristic magnetic field generation device 10 comprises at least one set of magnet groups 100. Each of the set of magnet groups 100 comprises a plurality of sets of magnetic field generation components 102, 104, 106, 108 (if the magnetic field generation component is a magnet, the magnetic field generation component can also be called as the magnet group, and for the sake of convenience, the words of the first, second, third and fourth magnet group are used, but the disclosure is not limited thereto). Each of the magnet groups 102 comprises a plurality of magnetic field generation device 102a, 102b. In this embodiment, the magnetic field generation components 102a, 102b are magnets, but the disclosure is not limited thereto. Any component that can generate the magnetic field is applicable to this disclosure. To simplify the wordings, the magnet is used for representing the magnetic field generation component hereinafter, but the magnetic field generation components 102a, 102b are not limited thereto. The arrangements of the magnets 102a, 102b of the magnet group 102, 104, 106, 108 in the single set of magnet groups are different (or are the same). In this embodiment, the different arrangements refer to the arrangements of the magnetic poles are different. Referring to FIG. 1, from left to right, the magnetic poles are arranged in sequence of SN, SS, NS, NN (though shown in double magnets in figure, the magnets can be arranged in a single or multiple manner). Specifically, S refers to a south magnetic pole towards the viewer (upward, namely a direction perpendicular to the paper). That is, the magnet's NS magnetic poles are arranged in a direction perpendicular to the paper of FIG. 1 with a downward N pole and an upward S pole; N refers to another magnet's Magnetic North Pole facing the viewer (namely upward), the Magnetic South Pole facing downward. Another magnet is next to the mentioned magnetic with S pole facing upward. Hence, each of the magnet group 102, 104, 106, 108 has one the characteristic magnetic field and the characteristic magnetic fields in the same set of magnet groups are different from each other (for example, but not limited to, SN, SS, NS, NN, and the detail will be explained at later stages).

In the arrangement of the set of magnet groups, the magnet distance d1 refers to the distance between the magnet 102a and the magnet 102b of the single magnet group 102, 104, 106, 108 (alternatively, the magnet distance d1 refers to the distance between the magnetic field generation components). The distance between two adjacent magnet groups 102 and 104 is defined as the group distance d2. The distance that the single set of magnet groups 100 is capable of determining positions is defined as the set distance d3. The influential range of the magnetic field generated by the single magnet group 102, 104, 106, 108 is defined as the effective magnet distance d4 (which will be explained at later stages).

Take the arrangement of the magnet 102a and 102b of this embodiment as an example. The number of the characteristic magnetic fields in the single set of magnet groups 100 is not greater than the index of power of 2 of the number of the magnets 102a and 102b in the single magnet group 102. That is, taking FIG. 1 as an example, the quantity of the magnets 102a and 102b of the single magnet group 102 is 2. As a result, the number of the characteristic magnetic fields is not greater than 2² (namely not greater than 4). In this embodiment, although the single set of magnet groups 102 has four magnet groups 102, 104, 106, 108, the disclosure is not limited thereto. The single set of magnet groups may have merely two or three magnet groups 102, 104, 106. When the number of the single magnet group is 3, the characteristic magnetic field in the single set of magnet groups 100 is not greater than 2³, namely not greater than 8.

Except being changed by the arrangement of magnetic poles, the aforementioned arrangement of magnets 102a and 102b can also be changed by different arrangement distances of magnets 102a and 102b, changes regarding the relative staked relationship between magnets 102a and 102b, or different magnets 102a and 102b with different level of magnetic forces. The detail will be explained at later stages.

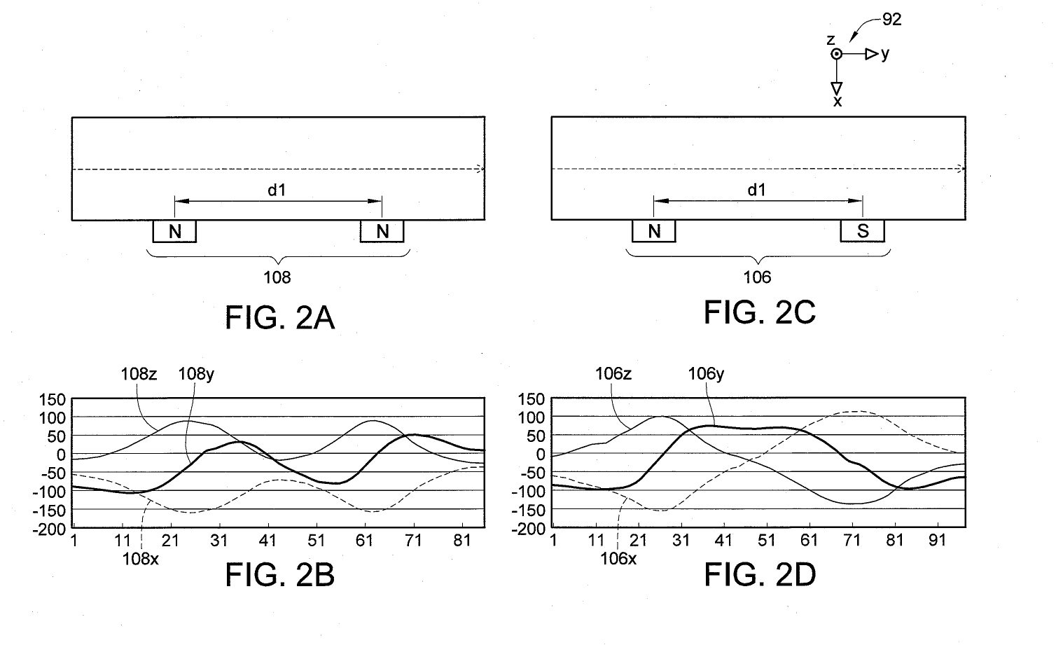

With regard to characteristic magnetic fields generated by different arrangements of magnets 102a and 102b, please refer to FIG. 2A, FIG. 2B, FIG. 2C and FIG. 2D, which are schematic graphs of characteristic magnetic fields generated by the magnet group. The coordinates of this figure can be found as the coordinate graph 92 at the upper right corner (the same as FIG. 1). According to the figure, the horizontal direction towards right is the positive Y direction, the downward direction perpendicular to the figure plane is the positive X direction, and the direction towards the viewer which is perpendicular to the paper is the positive Z direction. The coordinates of the client device 60 is the same as it of the predetermined space 90. FIG. 2A and FIG. 2B take the fourth magnet group as an example, while FIG. 2C and FIG. 2D take the third magnet group 106 as an example.

At first, according to FIG. 2A, the client device moves towards the positive Y direction. After moving along the whole path, the client device 60 detect the characteristic magnetic field along the path so that it reads and acquires the magnetic field signals 108x, 108y and 108z, as shown in FIG. 2B. FIG. 2D adopts the same way of FIG. 2C to acquire the magnetic field signals 106x, 106y and 106z. As shown in the FIG. 2B and FIG. 2D, the magnetic field signals with different arrangement of magnets read along the unidirectional axis may result in different characteristic magnetic fields. Take the magnetic field signals 108y and 106 y acquired along the Y axis as an example. 108 y's magnetic field characteristic refers to that the strength of magnetic force corresponding to the place of the magnet changes from negative to positive. The magnetic field characteristic of 106y refers to that the strength of the magnetic force changes from negative to positive when corresponding to the N magnetic pole magnet, and when corresponding to S magnetic pole magnet, the strength of the magnetic force changes from positive to negative. Consequently, by the changes of magnet arrangement, the magnet groups 102, 104, 106, 108 acquire different characteristic magnetic fields. After moving along the whole path (namely one effective magnet distance d4), the accumulated magnetic field signals acquired by the aforementioned client device 60 can be named as the unit characteristic. In other words, the effective magnet distance is the minimum distance that the single magnet group can form the corresponding unit characteristic. The length of the unit path corresponding to the unit characteristic is the minimum unit of the recognizable resolution that the disclosure is capable of. The minimum unit may be the aforementioned group distance d2, or may be the aforementioned effective magnet distance d4. As for the relationship between the effective magnet distance d4 and the group distance d2, the group distance d2 may be, but is not limited to, a value set based on the lower limit regarding the minimum distance, which are not overlapped (or interfered) with each other, of the effective magnet distance of the two adjacent magnet groups 106 and 108. Take FIG. 1 as an example, the minimum size of the group distance d2 of the adjacent magnet groups 106 and 108 is the half of the sum of the effective distances d4 of the two magnet groups 106 and 180, namely ½*(the effective magnet distance d4 of the magnet group 106+the effective magnet distance d4 of the magnet group 108). The upper limit of the group distance d2 depends on the predetermined space 90.

Subsequently, the aforementioned magnetic field characteristic database 22 has a plurality of characteristic values and a plurality of positioning values. Each characteristic value corresponds to each positioning value. The characteristic values correspond to the magnetic field characteristics. The characteristic values are the positioning values corresponding to the values of aforementioned 108x, 108y, 108z, 106x, 106y, 106z. In this embodiment, for example, the characteristic values of 108x, 108y, 108z correspond to the coordinates of the location of the fourth magnet group 108 in FIG. 1. The positioning values corresponding to the characteristic values of 106x, 106y, 106z are the coordinates of the location of the third magnet group 106 in FIG. 1. The aforementioned characteristic values may be, but is not limited to, the corresponding relationship between characteristic curves, values, proportions or 3 axes, or may be corresponding relationship between relative values or corresponding logic relationships. The aforementioned positioning values may be an absolute coordinates, or may be a relative increment which may be positive or negative. For example, if the predetermined space is the whole range of positioning detection, the positioning values can be the absolute coordinates. It is also possible to estimate a positioning point in the space via the measure of increment after going through a particular positioning point. For example, after acquiring the characteristic values of the third magnet group 106, the method, then, acquire the characteristics of the magnet group 108. When the group distance d2 of 106 and 108 is known, it can be known that the location is the positioning point of the location of the 106 magnetic field added by d2 (output positioning value by increment), and the rest can be deducted similarly. If a plurality of 108 magnet groups (for example, n groups) are disposed this way in the space and the group distances are all d2, the result is the multiple group distance (namely, n*d2) corresponding to the location of the third magnet group 106.

The aforementioned generation of the characteristic magnetic field is, for example, the magnet (the fixed magnet), but it is not limited thereto. It may be generated by the electronic magnet, or by the mix of the magnets and the electronic magnets.

To avoid confusion, the explanations of the characteristic magnetic field, characteristic values, unit characteristic, and magnetic field signal are introduced hereinafter. The characteristic magnetic field refers to the magnetic field generated by the magnet groups 102, 104, 106, 108 within the effective magnet distance d4. The characteristic value is the data stored in the magnetic field characteristic database 22. The magnetic field signal is the signal detected by the client device 60 in the single effective magnet distance d4 at the single time point. The unit characteristic is the signal value acquired by accumulating all the magnetic field signals in the single effective magnet distance by the client device 60. Similarly, the signal value may be, but is not limited to, the corresponding relationship between characteristic curves, values, proportions or 3 axes, or may be the corresponding relationship between relative values or corresponding logic relationships.

The aforementioned processing device 20 is configured for receiving the unit characteristic sent by the client device 60, and configured for looking for the characteristic value and the positioning value corresponding the to unit characteristic in the magnetic field characteristic database 22, so as to output the corresponding positioning value. The positioning value mentioned here may be, but is not limited to, sending the positioning value to the client device 60 to show them on the display of the client device 60, or to show them on the display of the system apparatus 50.

The aforementioned unit characteristic may be the characteristic value corresponding to the three axes, or may be the characteristic value corresponding to the one axis or two axes. When practicing, it may be depend on the identification ability or the performance. Furthermore, in order to improve the identification ability of the unit characteristic, the magnet distance d1 and the group distance d2 can be arranged accordingly to match different magnets or electronic magnetic fields.

Please refer to FIG. 1 again. The client device 60 comprises the magnetic field detecting component 62 and the processor 64. The magnetic field detecting component is configured for detecting the characteristic magnetic fields and outputting a magnetic field signal. When the processor 64 receives and processes the magnetic field signal and the magnetic field signal which has been processed forms (accumulates) a unit characteristic, the unit characteristic is transmitted to the processing device 20. Specifically, after the client device 60 moves a distance greater than or equal to the effective magnet distance d4 of the magnet group, the processor 64 acquires the unit characteristic. The magnetic field detecting component 62 may be, but is not limited to the signal curve, value, proportion, and corresponding relationship between three axes.

The coupling method between the processor 64 and the processing device 20 may be disposing a passing and receiving component 66 in the client device 60 and disposing a transceiver component 24 in the system apparatus 50. By the wire or wireless transmission between the passing and receiving component 66 and the transceiver component 24, the purpose of sending the unit characteristic to the system apparatus 50 by the client device 60 can be reached.

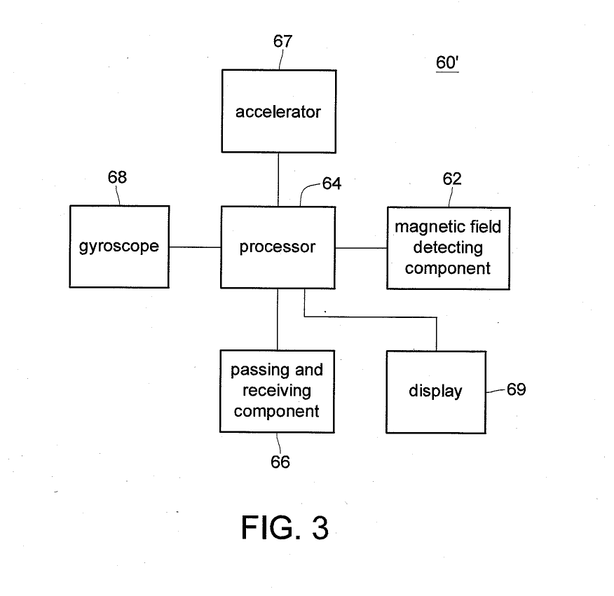

Then, please refer to FIG. 3, which is a block diagram of a magnet group according to another embodiment of the disclosure. As shown in the figure, the client device 60′ comprises a magnetic field detecting component 62, a processor 64, a passing and receiving component 66, an accelerator 67 and a gyroscope 68.

The client device 60′ is configured for moving in different speeds, different elevation angles, and different moving angle in the predetermined space 90. This condition is configured for the positioning method for people moving in a normal way. The client device 60 in FIG. 1 may be, but is not limited to, the positioning method for an automated transportation device, which indicate that the angle and the moving speed of the client device 60 in the automated transportation device has been set, so the correct unit characteristic can be obtained without considering the angle and the moving speed.

The accelerator 67 is configured for acquiring the acceleration value of the movement of the client device 60′. The gyroscope 68 is configured for acquiring the angle of the movement of the client device 60′. The processor 64 is configured for acquiring the unit characteristic based on the magnetic field signal, the acceleration value and the angle.

When the processor 64 acquires the unit characteristic based on the magnetic field signal, the acceleration value and the angle, the acceleration value and the velocity of the movement of the client device 60′ are taken into consideration. Thus, after a normalization process, the magnetic field signal can be normalized to be within the time length of the unit characteristic appropriately. Meanwhile, the processor is also configured for calculating the component of the vector along the x, y or z direction based on the angle of the movement, to acquire the unit characteristic of the one, two or three axes. Thereby, the unit characteristic sent to the processing device 20 can fit the characteristic values in the magnetic field characteristic database more appropriately, so as to facilitate the processing device 20 to look up.

Moreover, the client device 60′ may further comprise a display 69. Similarly, when the processing device 20 of the system apparatus 50 sends the positioning value, the processor is configured for acquiring the positioning value via the passing and receiving component 66 and the transceiver component 24. Hence, the processor can display the positioning value on the display 69

Unit characteristic: as for the determination of whether the magnetic field signal collected form a unit characteristic, it can be carried out, but not limited to, in the following ways:

At first, the explanation is made according to the collection method of the unit characteristic which is able to be adopted by the client device 60 in FIG. 1. Similarly, in FIG. 1, the client device 60 is related to the positioning method which can be applied for the automated transportation device, but it is not limited thereto. In this circumstance, the magnetic field detecting component 62 of the client device 60 disposed on the automated transportation device has been set to a predetermined angle related to the moving direction. The moving speed of the automated transportation device, meanwhile, is constant.

In FIG. 1, the client device utilizes the characteristic magnetic field with the natural magnetic field (namely geomagnetism) to determine whether the client device 60 has moved a complete effective magnet distance d4 and acquire the unit characteristic. When being used in the automated transportation device, the aforementioned group distance d2 can be adjusted appropriately to make the magnetic force strength stronger when the client device 60 moves and passes through a certain magnet group 104, and make the magnetic force strength weaker when moving to the center point of the adjacent two magnet groups 104 and 106. Thus, when the processor 64 find that the magnetic field is greater than a first threshold value, it starts collecting the magnetic field signal. When the magnetic field is less than a second threshold value, the processor 64 stops collecting the magnetic field signal. The processor 64 is configured for transferring the magnetic field signal collected in this period to the unit characteristic through a magnetic field signal process, and transmit the unit characteristic to the processing device 20 for comparison and identification. The aforementioned first threshold value and second threshold value can be the same value or a certain proportion relationship, which depends on the real situation.

According to the above-mentioned description, in this application environment, since the moving speed and the angle of the movement of the client device 60 are known, the components disposed on the client device 60 are relatively simple and the processing speed of the processor 64 is relatively fast. Additionally, as for the application regarding multiple sets of magnet groups 100, the set distance d3 of the set of magnet groups 100 can be adjusted in order to cause the interval difference between the number of the magnetic field of the magnet groups 102, 104, 106, 108 are different from the interval between the magnet groups in the other set of magnet groups 100. Thereby, the processor 64 is configured for utilizing the different interval differences to determine whether the client device 60 has crossed the one set of magnet groups 100.

Then, in FIG. 3, except for the combination of the characteristic magnetic field and the natural magnetic field, the collection method of the client device 60′ may also apply a method involving calculating the moving distance of the client device 60′.

As mentioned before, the client device 60′ has the accelerator 67 and the gyroscope 68. Hence, the processor 64 is configured acquiring the speed, acceleration, gyroscope 68 of the client device 60′. These information can not only be used to adjust the magnetic field signal received, but also be used to calculate the finished path and distance of the client device 60′. When the client device 60′ has finished a complete effective magnet distance d4, the processor 64 is configured for integrating the accumulated magnetic field signal collected and form the unit characteristic. The integrating process may comprise the normalization (or standardization), and the normalization process may comprise the calculation of components of the vector and the calculation of the magnetic field signal (the client device 60′ moves along a single group distance).

The acquisition and the process of the unit characteristic in the aforementioned embodiments are completed by the client device 60 and 60′, but the disclosure is not limited thereto. The client device may send the relevant information to the system apparatus 50 to perform the unit characteristic process. The relevant information may be, but is not limited to, the magnetic field signal, speed, acceleration and angle.

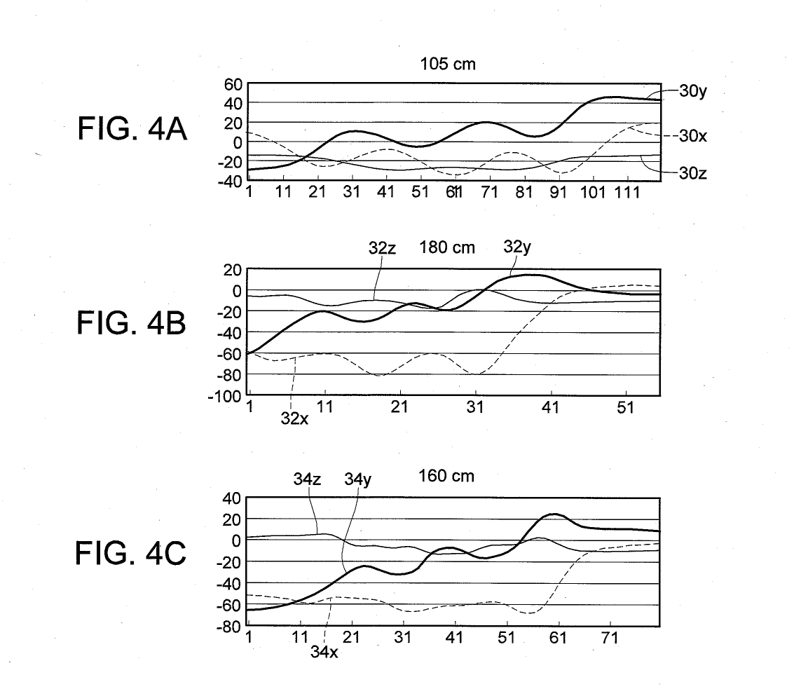

Characteristic Magnetic Field: as for the arrangement of the predetermined space and the generation of the characteristic magnetic field, please refer to FIG. 4A, FIG. 4B and FIG. 4C, which are line graphs of characteristic magnetic fields of the magnet group under different measuring heights according to the disclosure.

In this embodiment, the single magnet group comprises three magnets. The magnet distance d1 is 60 cm. The effective magnetic field is 200 cm. These magnets are arranged in the NNN array, with a height of 75.5 cm. FIG. 4A is the magnetic field signal acquired at the height of 105 cm. The FIG. 4B is the magnetic field signal acquired at the height of 180 cm. FIG. 4C is the magnetic field signal acquired at the height of 160 cm. 30x, 32x and 34x each represents the magnetic field signal detected along the X axis direction. 30y, 32y and 34y each represents the magnetic field signal detected along the Y axis direction. 30z, 32z and 34z each represents the magnetic field signal detected along the Z axis direction. According to these three figures, the magnetic field signal detected along the Y axis direction is relatively clear and consistent. Therefore, when applying the single axis magnetic field signal to be the unit characteristic, the magnetic field signal detected along the Y axis direction can be adopted. In this embodiment, Y axis refers to the axis parallel to the moving direction (please refer to the path of the client device 60 of the coordinates 92 in FIG. 1, namely the direction pointed by the arrow with the dotted line).

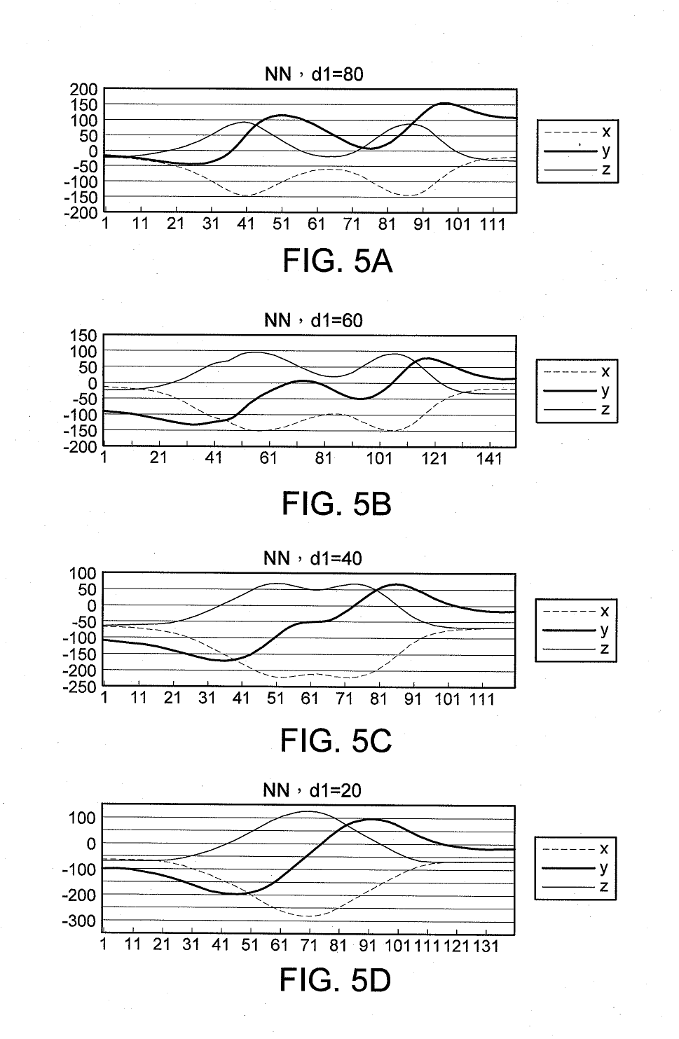

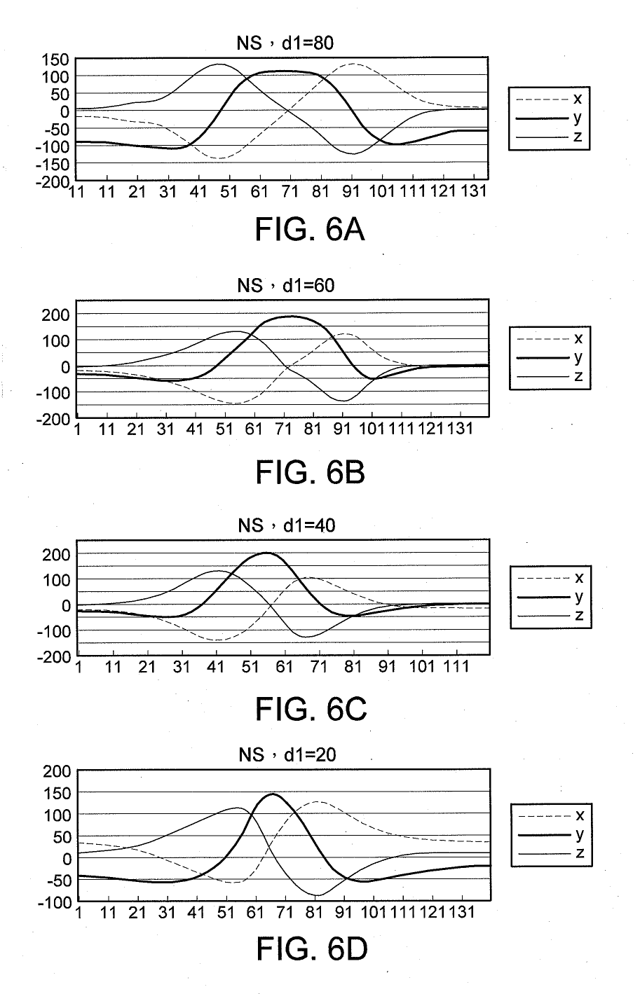

Then, please refer to FIGS. 5A, 5B, 5C, 5D, 6A, 6B, 6C and 6D, which are line graphs of characteristic magnetic fields of the magnet group under the magnet distance and the magnetic pole arrangement. FIGS. 5A, 5B, 5C and 5D adopt the arrangement of NN array. The magnet distances d1 of FIGS. 5A, 5B, 5C and 5D are 80 cm, 60 cm 40 cm and 20 cm respectively. FIGS. 6A, 6B, 6C and 6D adopt the arrangement of NS array. The magnet distances d1 of FIGS. 6A, 6B, 6C and 6D are 80 cm, 60 cm 40 cm and 20 cm respectively.

As shown in FIGS. 5A, 5B, 5C, 5D, 6A, 6B, 6C and 6D, after reducing the magnet distance d1, the feature of the arrangement of the NS array is still clear, while that of NN array is relatively less clear. Hence, given that reducing the effective magnet distance d4 is desirable, when creating more magnetic field characteristics in a smaller space (to acquire a smaller positioning accuracy), the NS array in a stagger form may be adopted in the single set of magnet groups 100.

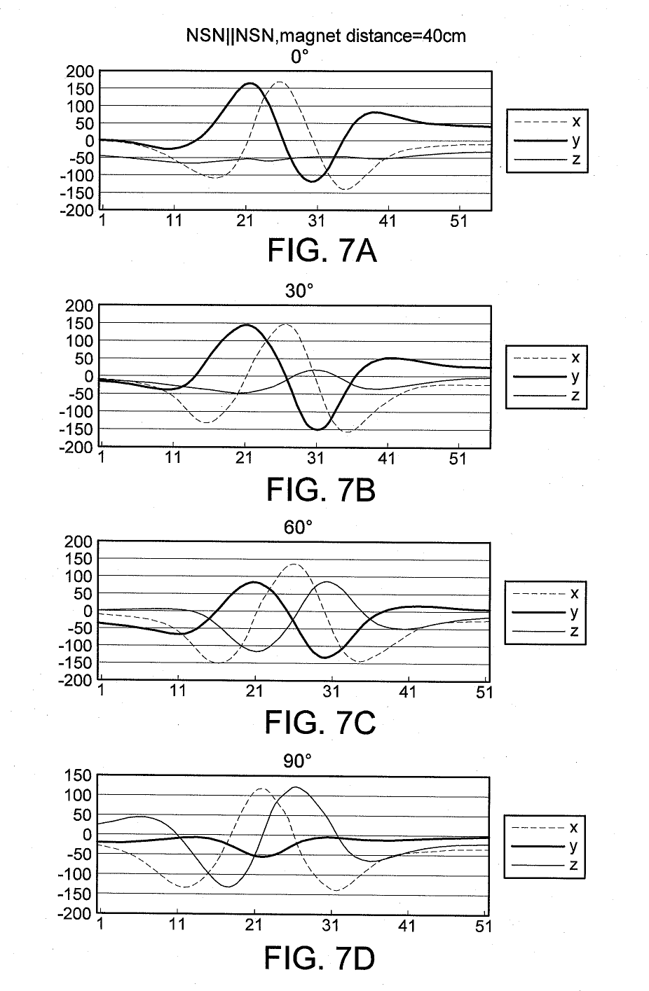

Moreover, please refer to FIGS. 7A, 7B, 7C and 7D, which are line graphs of characteristic magnetic fields of the set of magnets under different elevation angles according to the disclosure. The characteristic magnetic field is the magnetic field signal detected when the magnet group (NSN) is at about 90 cm height, the magnet distance is 40 cm and the height of the sensor is at 180 cm. FIG. 7A refers to the magnetic field signal acquired when the angle between the Y axis of the client device 60′ and the Y axis of the predetermined space is 0 degree. FIG. 7B refers to the magnetic field signal acquired when the angle between the Y axis of the client device 60′ and the Y axis of the predetermined space is 30 degrees. FIG. 7C refers to the magnetic field signal acquired when the angle between the Y axis of the client device 60′ and the Y axis of the predetermined space is 60 degrees. FIG. 7D refers to the magnetic field signal acquired when the angle between the Y axis of the client device 60′ and the Y axis of the predetermined space is 90 degrees.

As shown in FIGS. 7A, 7B, 7C and 7D, as the included angle between the moving direction of the client device 60′ and the Y axis increases, the axial component of the projected moving direction on Y axis decreases. As a result, the Y axis's characteristic recognition may be unsatisfactory. At this point, the Y axis's characteristic should be replaced by the axial direction parallel to the moving direction (e.g. −Z axis when the included angle is 90 degrees). As shown in the above-mentioned explanation, if magnets with the same magnetic force strength are used as the basic components of characteristic magnetic field generation, the appropriate arrangement of the magnetic poles, the change of magnet distance d1 and the change of group distance d2, accompanied with appropriate detector information, different characteristic magnetic fields and the required positioning accuracy (resolution) can be obtained.

In the existing characteristic magnetic field, the characteristic values of the corresponding magnetic field characteristic database 22 may be generated by several methods. In the first method, in the installation of the system apparatus 50, create the characteristic values corresponding to various kinds of the characteristic magnetic fields in the development stage, and directly establish them in the magnetic field characteristic database 22. When the processing device 20 looks up the magnetic field characteristic database 22 via the unit characteristic, the identification is conducted by the method of value fitting (value matching or curve fitting). A tolerable error should be added to this identification method, in order to find the characteristic value corresponding to the unit characteristic more quickly. The tolerable error can be set according the practical experience and the factors which should be considered includes the strength of the natural magnetic field in the predetermined space 90, the strength of the magnetic force of the magnet groups 102 and 104, and the size of the predetermined space 90.

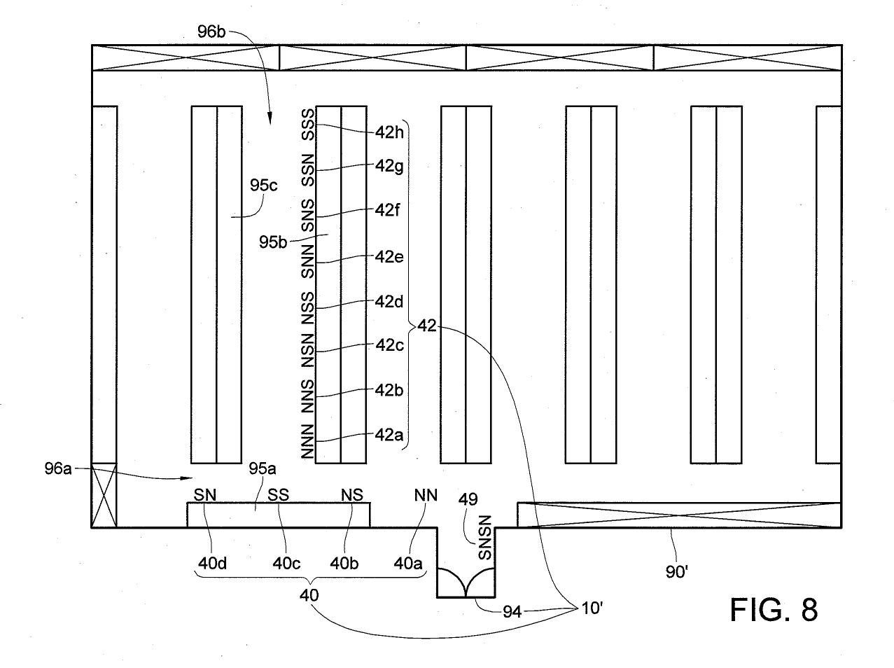

Two-dimensional Positioning: the applications of the positioning method in the above-mentioned embodiments are conducted by the single axis positioning. The two-dimensional positioning is illustrated in FIG. 8. FIG. 8 is a schematic view of a characteristic magnetic field generation device disposed in a predetermined space according to another embodiment of the disclosure.

In FIG. 8, it can be seen that the predetermined space 90 is a shopping mall, and the entrance disposes an origin magnetic field generation component group 49 (also called original magnet group) to generate the origin characteristic magnetic field which will be explained at later stages. A plurality of shelves 95a, 95b and 95c and their corresponding aisles 96a and 96b are disposed in the predetermined space 90′. For the convenience in terms of explanation, only two aisles 96a and 96b disposing the sets of magnet groups 40 and 42 are illustrated. That is, the characteristic magnetic field generation device 10′ comprises two sets of magnet groups 40 and 42 (which are named the first set of magnet groups 40 and the second set of magnet groups 42) and an origin magnetic field generation component group 49.

As shown in the figure, the arrangement of the magnets of the origin magnetic field generation component group 49 is SNSN. The first set of magnet groups 40 comprises the magnet groups 40a, 40b, 40c and 40d. Each of the magnet groups 40a, 40b, 40c and 40d has two magnets and they are arranged in the manner of NN, NS, SS and SN respectively. The second set of magnet groups 42 comprises the magnet groups 42a, 42b, 42c, 42d, 42e, 42f, 42g, 42h. Each of the magnet groups 42a, 42b, 42c, 42d, 42e, 42f, 42g in the second set of magnet groups 42 has three magnets and the magnets are arranged in the manner of NNN, NNS, NSN, NSS, SNN, SNS, SSN and SSS respectively.

The first set of magnet groups 40 and the second set of magnet groups 42 are located in different areas. Therefore, when the unit characteristic returned by the client devices 60 and 60′ corresponds to a certain characteristic value, the positions of the client devices 60 and 60′ are known. In this embodiment, the origin magnetic field generation component group 49 is configured for origin triggering when the client devices 60 and 60′ enters into the shopping mall. When the unit characteristic and the origin characteristic value are identical, it indicates that the client devices 60 and 60′ are at the gateway of the shopping mall. Then, the acquisition and comparison based on other unit characteristics can be made to determine the position of the client devices 60 and 60′ at the time.

In this embodiment, the characteristic magnetic field generated by the characteristic magnetic field generation device 10 does not repeat. That is, one characteristic magnetic field represents one coordinate in the predetermined space 90′, but the disclosure is not limited thereto. The characteristic magnetic field generation device 10 may generate the repeated magnetic field, as long as it accompanies with appropriate accumulation skills or the arrangement of the origin characteristic magnetic field, to perform the two-dimensional plane positioning.

Moreover, with regard to the arrangement of the aforementioned magnets 102a and 102b, the arrangement may utilize different magnetic materials, different magnetization methods, or different shapes of magnets to generate different characteristic magnetic fields. The said different magnetic materials may utilize different magnetic materials (e.g. ferrite, NdFeB) to magnetize, but they are not limited thereto. Different magnetization methods may adopt magnets with different levels of magnetic forces, and the disclosure is not limited thereto.

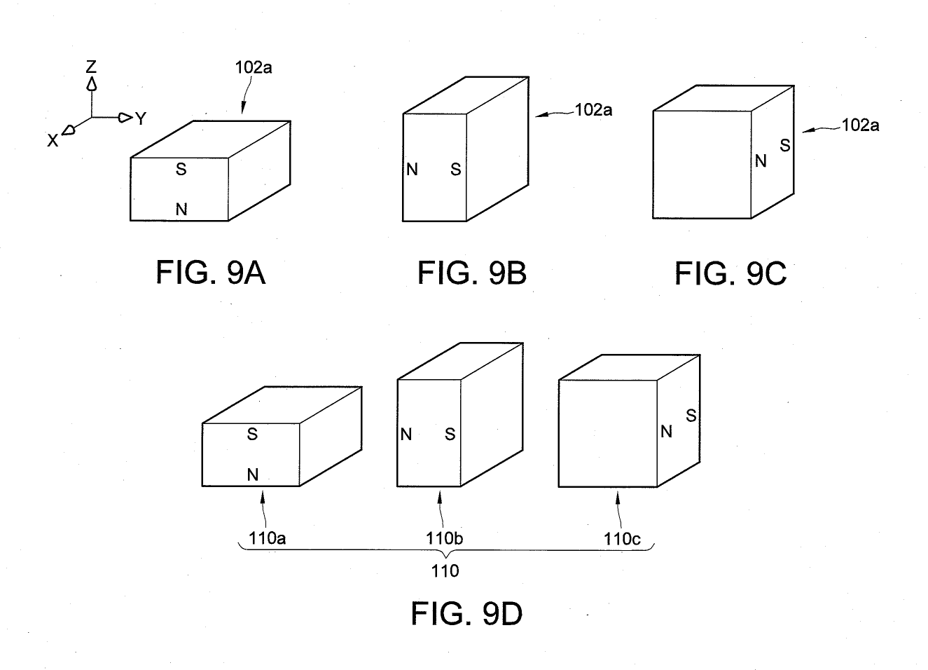

The aforementioned arrangement may adopt arrangements of different stacking or different combinations. Please refer to FIGS. 9A, 9B, 9C and 9D. FIGS. 9A, 9B, 9C and 9D are perspective views of the arrangement of magnets according to the disclosure. The arrangement of FIG. 9A is to put the single magnet 102a in a vertical magnetic pole arrangement. That is, S pole is facing +Z axis, while N pole is facing −Z axis. In FIG. 9B, the arrangement is to make the S pole of the single magnet 102a face +Y axis, while N pole −Y axis. In FIG. 9C, the arrangement is to make the S pole of the single magnet 102a face +X axis, while N pole −X axis. In FIG. 9D, however, the arrangement is the combination of the arrangements of FIG. 9A, FIG. 9B and FIG. 9C to form the aforementioned the single magnet group 110. In FIG. 9D, the magnet group 110 comprises three magnets 110a, 110b and 110c. Each of the magnets 110a, 110b and 110c has different arrangements. Additionally, the magnetic force strength of each of the magnets 110a, 110b and 110c may be different. For example, the magnetic fields of each of magnets are, but not limited to, 3000 Gauss, 1000 Gauss and 3000 Gauss respectively. Also, the distance between each of the magnets 110a, 110b and 110c may be different. For example, the distance between the first magnet 110a and the second magnet 110b may be less than that between the second magnet 110b and the third magnet 110c.

Lastly, there are multiple arrangements regarding the magnet 102a. Therefore, when the arrangement of a magnet along a moving direction is NSNS and the returned magnetic field signal is SNSN, it can be determined that the current moving direction of the client devices 60 and 60′ is opposite to said certain direction. In other words, except for the comparison of the single magnetic field characteristic, the processing device 20 of the system apparatus 50 is configured for estimating the current path and the moving direction of the client device 60 and 60′ based on the sequential relationship of the characteristic magnetic field.

Though the disclosure is represented by the aforementioned embodiments illustrated above, it is not limited thereto. For example, in above-mentioned embodiments, the unit characteristic is obtained by receiving and processing the magnetic field signal by the processor 64 of the client devices 60 and 60′, but the disclosure is not limited thereto. In other embodiments, part of or all information such as the magnetic field signal detected and acquired by the magnetic field detecting component 62, the acceleration value acquired by the accelerator 67, and the movement angle acquired by the gyroscope 68 can be sent to the processing device 20 by the processor 64 directly, and the processing device 20 is configured for acquiring the unit characteristic upon the magnetic field signal, the acceleration value and/or the angle.

Furthermore, the positioning system based on the magnetic field characteristic comprises the system apparatus 50 and the client device 60 and 60′. The system apparatus 50 comprises the characteristic magnetic field generation devices 10 and 10′, the magnetic field characteristic database 22 and the processing device 20. The client devices 60 and 60′ comprises the magnetic field detecting component 62 and the processor 64. The characteristic magnetic field generation devices 10 and 10′ generates a plurality of characteristic magnetic fields in a predetermined space. The characteristic magnetic fields have at least two different magnetic field characteristics. The magnetic field characteristic database 22 has a plurality of characteristic values and a plurality of positioning values. Each characteristic value corresponds to each positioning value. The characteristic values correspond to the magnetic field values. The magnetic field detecting component 62 detects the characteristic magnetic fields and output a magnetic field signal. The processor receives and transmits the magnetic field signal to the processing device. The processing device processes the magnetic field signal to obtain a unit characteristic. The processing device also looks up the characteristic value and the positioning value corresponding to the unit characteristic in the magnetic field characteristic database and then outputs the corresponding positioning value.

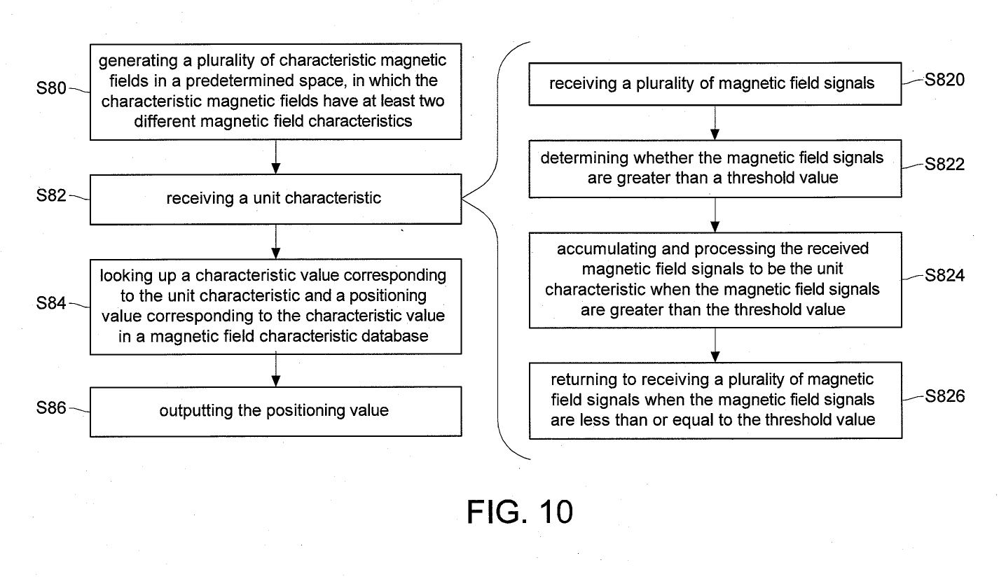

Positioning Method Based on the Magnetic Field Characteristic: subsequently, please refer to FIG. 10, which is a flow chart of the method for positioning based on magnetic field characteristics according to the disclosure.

Positioning method based on the magnetic field characteristic comprises the steps of:

S80: generating a plurality of characteristic magnetic fields in a predetermined space, in which the characteristic magnetic fields have at least two different magnetic field characteristics;

S82: receiving a unit characteristic;

S84: looking up a characteristic value corresponding to the unit characteristic and a positioning value corresponding to the characteristic value in a magnetic field characteristic database; and

S86: outputting the positioning value.

As mentioned before, in S80, generating a plurality of characteristic magnetic fields in a predetermined space further comprises generating an origin characteristic magnetic field. In S82, the characteristic may be from the client devices 60 and 60′, and the client devices 60 and 60′ send the unit characteristic after moving a predetermined distance in the predetermined space. The client devices 60 and 60′ are configured for generating the unit characteristic based on a movement acceleration thereof, a movement angle thereof, and a magnetic field signal acquired by detecting the characteristic magnetic field.

Furthermore, the unit characteristic in S82 can be acquired by the system apparatus 50 and the method thereof comprises the steps of:

S820: receiving a plurality of magnetic field signals;

S822: determining whether the magnetic field signals are greater than a threshold value;

S824: accumulating and processing the received magnetic field signals to be the unit characteristic when the magnetic field signals are greater than the threshold value; and

S826: returning to receiving a plurality of magnetic field signals when the magnetic field signals are less than or equal to the threshold value.

What is claimed is:

1. A system for positioning based on magnetic field characteristics, comprising:
a system apparatus, comprising:
a characteristic magnetic field generation device configured for generating a plurality of characteristic magnetic fields in a predetermined space, the characteristic magnetic fields having at least two magnetic field characteristics
a magnetic field characteristic database having a plurality of characteristic values and a plurality of positioning values, each of the characteristic values corresponding to each of the positioning values, the characteristic values corresponding to the magnetic field characteristics; and
a processing device; and
a client device, comprising:
a magnet detecting component configured for detecting the magnetic field characteristics and for outputting a magnetic field signal; and
a processor configured for collecting and processing the magnetic field signal, wherein when the magnetic field signal which has been processed generates a unit characteristic, the processor is configured for transmitting the unit characteristic to the processing device, and after looking for one of the characteristic values corresponding to one of the positioning values, the processing device is configured for outputting the corresponding positioning value.

2. The system for positioning based on magnetic field characteristics according to claim 1, wherein the characteristic magnetic field generation device comprises at least one set of magnet groups, the at least one set of magnet groups comprises a plurality of magnetic field generation component groups, each of the magnetic field generation component groups comprises a plurality of magnetic field generation components, and each of the magnetic field generation component groups has a characteristic magnetic field.

3. The system for positioning based on magnetic field characteristics according to claim 2, wherein the processor is configured for moving a distance greater than or equal to an effective magnet distance in the predetermined space and acquiring the unit characteristic, wherein the effective magnet distance is the minimum distance that the single magnetic field generation component group is configured for forming the corresponding unit characteristic.

4. The system for positioning based on magnetic field characteristics according to claim 1, wherein the client device further comprises:
an accelerometer configured for acquiring an acceleration value of the movement of the client device while the client is moving; and
a gyroscope configured for acquiring an angle of the movement of the client device;
wherein the processor is configured for acquiring the unit characteristic based on the magnetic field signal, the acceleration value and the angle.

5. The system for positioning based on magnetic field characteristics according to claim 1, wherein the characteristic magnetic field generation device further comprises an origin magnetic field generation component group.

6. A system for positioning based on magnetic field characteristics comprising a system apparatus, the system apparatus being configured for collecting a unit characteristic, the system apparatus comprising:
a characteristic magnetic field generation device configured for generating a plurality of characteristic magnetic fields, the characteristic magnetic fields having at least two magnetic field characteristics;
a magnetic field characteristic database having a plurality of characteristic values and a plurality of positioning values, each of the characteristic values corresponding to the positioning values, the characteristic values corresponding to the magnetic field characteristics; and
a processing device configured for receiving the unit characteristic, and after looking for one of the characteristic values corresponding to one of the positioning values, the processing device being configured for outputting the corresponding positioning value.

7. The system for positioning based on magnetic field characteristics according to claim 6, wherein the characteristic magnetic field generation device comprises at least one set of magnet groups, the at least one set of magnet groups comprises a plurality of magnetic field generation component groups, each of the magnetic field generation component groups comprises a plurality of magnetic field generation components, each of the magnetic field generation component groups has a characteristic magnetic field.

8. The system for positioning based on magnetic field characteristics according to claim 6, wherein the characteristic magnetic field generation device further comprises an origin magnetic field generation component group.

9. A system for positioning based on magnetic field characteristics comprising a client device, the client device being configured for a predetermined space with a plurality of characteristic magnetic fields, the client device comprising:
a magnetic field detecting component configured for detecting the characteristic magnetic fields and outputting a magnetic field signal; and
a processor configured for receiving and processing the magnetic field signal, and configured for outputting a unit characteristic when the magnetic field signal which has been processed forms the unit characteristic.

10. The system for positioning based on magnetic field characteristics according to claim 9, wherein the processor is configured for acquiring the unit characteristic after the client device moves a distance greater than or equal to an effective magnet distance of the magnetic field generation component group in the predetermined space and configured for acquiring the unit characteristic, wherein the effective magnet distance is the minimum distance of the unit characteristic that the single magnetic field generation component group can form and correspond.

11. The system for positioning based on magnetic field characteristics according to claim 9, wherein when the magnetic field signal is less than a threshold value, the processor is configured for processing the magnetic field signal which has been received, so as to acquire the unit characteristic.

12. The system for positioning based on magnetic field characteristics according to claim 9, wherein the client device further comprises:
an accelerometer configured for acquiring an acceleration value of the movement of the client device;
a gyroscope configured for acquiring an angle of the movement of the client device;
wherein the processor is configured for acquiring the unit characteristic based on the magnetic field signal, the acceleration value and the angle.

13. A method for positioning based on magnetic field characteristics, comprising:
generating a plurality of characteristic magnetic fields in a predetermined space, the characteristic magnetic fields have at least two magnetic field characteristics;
receiving a unit characteristic;
looking for a characteristic value corresponding to the unit characteristic and a positioning value corresponding to the characteristic value; and
outputting the positioning value.

14. The method for positioning based on magnetic field characteristics according to claim 13, wherein the unit characteristic is from a client device, the client device is configured for sending the unit characteristic after moving a predetermined distance in the predetermined space.

15. The method for positioning based on magnetic field characteristics according to claim 14, wherein the client device is configured for generating the unit characteristic based on a movement acceleration of the client device, a movement angle of the client device, a magnetic field signal acquired by detecting the characteristic magnetic field.

16. The method for positioning based on magnetic field characteristics according to claim 14, wherein the predetermined space generating a plurality of characteristic magnetic fields further comprises generating an origin characteristic magnetic field.

17. The method for positioning based on magnetic field characteristics according to claim 13, wherein receiving the unit characteristic comprises:
receiving a plurality of magnetic field signals;
determining whether the magnetic field signals are greater than a threshold value
when the magnetic field signals are greater than the threshold value, accumulating and processing the magnetic field signals, which have been received, so as to make the magnetic field signals become the unit characteristic; and
when the magnetic signals are equal to or less than the threshold value, back to receiving the magnetic field signals.

18. The method for positioning based on magnetic field characteristics according to claim 13, wherein the method for generating the characteristic magnetic field is utilizing an electromagnet, a magnet or a combination of the electromagnet and the magnet to generate the characteristic magnetic fields.

19. The method for positioning based on magnetic field characteristics according to claim 13, wherein the method for generating the characteristic magnetic fields is through different magnetic materials, different magnetization method, different shapes of magnets, different stacks, different combinations, different levels of magnetic force, and different spacing arrangements.

20. The method for positioning based on magnetic field characteristics according to claim 13, wherein the characteristic value is a characteristic curve, a value, a proportion, or a corresponding relationship or an interchanging relationship.

21. The method for positioning based on magnetic field characteristics according to claim 13, further comprising acquiring a moving direction based on the characteristic magnetic field.

22. The method for positioning based on magnetic field characteristics according to claim 13, wherein the positioning value is an absolute coordinate or a relative increment.

23. A system for positioning based on magnetic field characteristics, comprising:
a system apparatus, comprising:
a characteristic magnetic field generation device configured for generating a plurality of characteristic magnetic fields, the characteristic magnetic fields having at least two magnetic field characteristics; and
a magnetic field characteristic database having a plurality of characteristic values and a plurality of positioning values, each of the characteristic values corresponding to each of the positioning values, the characteristic values corresponding to the magnetic field characteristics; and
a processor device; and
a client device, comprising:
a magnetic field detecting component configured for detecting the characteristic magnetic fields and for outputting a magnetic field signal; and
a processor configured for receiving the magnetic field signal and transmitting the signal to processing device, the processing device being configured for processing and acquiring a unit characteristic and looking up the characteristic value corresponding to the unit characteristic and the positioning value corresponding to the unit characteristic before outputting the positioning value corresponding to the unit characteristic.

24. The system for positioning based on magnetic field characteristics according to claim 23, wherein the characteristic magnetic field generation device comprises at least one set of magnet group, the at least one set of magnet group comprises a plurality of magnetic field generation component groups, each of the magnetic field generation component groups comprises a plurality of magnetic field generation components, and each of the magnetic field generation component groups has one the characteristic magnetic field.

25. The system for positioning based on magnetic field characteristics according to claim 23, wherein the processor is configured for moving a distance greater than or equal to an effective magnet distance in a predetermined space before acquiring the unit characteristic, wherein the effective magnet distance is the minimum distance of the unit characteristic that the single magnetic field generation component group can form and correspond.

26. The system for positioning based on magnetic field characteristics according to claim 23, wherein the client device further comprises:
an accelerometer configured for acquiring an acceleration value of the movement of the client device; and
a gyroscope configured for acquiring an angle of the movement of the client device;
wherein the processor is configured for acquiring the unit characteristic based on the magnetic field signal, the acceleration value and the angle.

27. The system for positioning based on magnetic field characteristics according to claim 23, wherein the characteristic magnetic field generation device further comprises an origin magnetic field generation component group.
